(19) United States
(12) Patent Application Publication
(10) Pub. No.: US 2025/0264618 A1
(43) Pub. Date: Aug. 21, 2025

(54) RF Lens Based Circularly Polarized Satellite Antenna Tracking System

(71) Applicant: Matsing, Inc., Irvine, CA (US)

(72) Inventors: Serguei Matitsine, Irvine, CA (US); Igor Timofeev, Irvine, CA (US); John Stewart Wilson, Irvine, CA (US)

(21) Appl. No.: 19/055,271

(22) Filed: Feb. 17, 2025

Related U.S. Application Data
(60) Provisional application No. 63/554,845, filed on Feb. 16, 2024.

(51) Int. Cl. G01S 19/24; H01Q 15/02

(52) U.S. Cl. CPC G01S 19/24; H01Q 15/02

(57) ABSTRACT

An antenna system for tracking multiple satellites comprises an RF lens (homogeneous or multiple layer Luneburg) with numerous feeds placed around the lens in a tightly packed arrangement to maintain high cross-over points between beams and high circularity. High-quality circular polarization, consisting of low axial ratio and low cross polarization levels, is maintained using a novel dielectric slab to compensate for the slight mismatch in phase delay through the lens from the two canonical polarizations vertical and horizontal. A weighted combination of beams is used to keep the resultant beam peak fixed on a satellite with the ability to use this approach in a number of places simultaneously, and simultaneously using one or more of these methods at multiple frequency bands.

This application claims priority to U.S. provisional application Ser. No. 63/554,845 filed Feb. 16, 2024. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

### FIELD OF THE INVENTION

The field of the invention is antenna systems and specifically satellite tracking antenna systems.

### BACKGROUND

The following description includes information that may be useful in understanding the present invention. It is not an admission that any of the information provided herein is prior art or relevant to the presently claimed invention, or that any publication specifically or implicitly referenced is prior art.

Antenna systems for tracking satellites have been well established since the 1950s. Satellites can be categorized as geostationary or non-geostationary, where non-geostationary includes medium and low earth orbit satellites. Similarly, antenna systems for tracking satellites can be for geostationary satellites, where the individual beams from the antenna are fixed, or non-geostationary where one or more approaches are used to track the satellite through the sky. Traditionally metal parabolic reflector antennas have been used in a fixed position for geostationary satellites, or a gimballed system where the reflector moves to track a single satellite through the sky.

An RF lens allows for multiple feeds in the same or different frequency bands to be placed around the lens and maintain equal pattern performance regardless of position. For satellite tracking, as the satellite passes through the peak of a given beam the received signal should be nearly identical from beam to beam simplifying the processing required to accurately track one or more satellites. An example can be found in U.S. Pat. No. 8,854,257, which uses a spherical Luneburg Lens surrounded by a large number of feeds is presented. That system results in “blur spots”, which compromise focal positions where the group of elements combine for a monopulse feature of sum and difference patterns. In addition, systems according to U.S. Pat. No. 8,854,257 cannot be used for wideband/dual-band applications. Bandwidth is limited by increasing gain loss in the gaps between beams; i.e. the prior art cannot provide smooth beam scanning and tracking when wideband or dual-band operation is needed.

Alternatives to the RF lens approach mostly consist of multiple feed reflector antennas or phase array antennas. Reflector antennas with multiple feeds are frequently used to receive signals from a group of adjacent geosynchronous satellites, but are limited to a handful of adjacent, or nearly adjacent, geosynchronous satellites and cannot be used to track non-geosynchronous satellites.

Known array antennas to track multiple targets include the Pave-Paws target tracking system, see https://en.wikipedia.org/wiki/PAVE_PAWS. The major drawback of using arrays is change in pattern performance at different directions. Unlike a Luneburg lens an array will have best pattern performance in a direction normal to the face of the array, and less aperture efficient and poorer performance off the normal direction. The issue can be mitigated by using an array surface other than a flat plate, such as a cylindrical surface but a larger, and hence less efficient, aperture is required for equivalent performance.

Thus, there is still a need for satellite tracking antenna systems that use circularly polarized antenna elements to track multiple satellites.

### SUMMARY OF THE INVENTION

The inventive subject matter provides an antenna system comprising an RF lens (homogeneous or multiple layer Luneburg) with numerous feeds placed around the lens in a tightly packed arrangement to maintain high cross-over points between beams and high circularity. High-quality circular polarization, consisting of low axial ratio and low cross polarization levels, is maintained using a novel dielectric slab to compensate for the slight mismatch in phase delay through the lens from the two canonical polarizations vertical and horizontal.

Preferred embodiments use a receive, transmit, or transmit/receive (T/R) chain consisting of power amplifiers (PA), low noise block downconverters (LNB) and Analog to Digital (A/D) and Digital to Analog (D/A) devices in a processing scheme to track satellites. This provides a clean approach that relies on the accuracy of the A/D and D/A devices.

Signal information is processed from a group of feeds, where the signal from each feed is derived from a highly efficient feed by optimizing feed focal positions.

The described methods and apparatus include a single feed assigned to a single satellite as would be the case for geosynchronous satellites, hand off from beam to beam for medium and low earth orbit satellites, using a weighted combination of beams to keep the resultant beam peak fixed on a satellite with the ability to use this approach in a number of places simultaneously, and simultaneously using one or more of these methods at multiple frequency bands.

The feeds can operate over traditional radar bands such as L-Band (1-2 GHz), S-Band (2-4 GHz), C-Band (4-8 GHz), X-Band (8-12 GHz), Ku-Band (12-18 GHz), K-Band (18-27 GHz), and Ka-Band (27-40 GHz).

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

### BRIEF DESCRIPTION OF THE DRAWINGS

FIG. 1 shows prior art where a number of patch antennas are arranged around a Luneburg lens to produce a mono-pulse satellite tracking system.

FIG. 2 shows an arrangement of 454 feeds according to the present invention for placement around a Luneburg lens for the purpose of tracking satellites.

FIG. 3 shows the complete antenna system for tracking satellites over approximately one third of the upper hemisphere.

FIG. 4 shows one embodiment of a single band dual circular polarized feed arrangement of closely packing the feeds

FIGS. 5A and 5B shows the top and bottom, respectively, of one embodiment of a single band dual circular polarized feeds.

FIG. 6 is a graph showing a method of tracking satellites using a single beam and combining adjacent beams.

FIG. 7 is a graph showing a method of tracking using a single beam and an unequal weighting of two adjacent beams.

FIG. 8 shows a dual band feed arrangement with a lower frequency feed surrounded by higher frequency feeds; the relative position of the higher band feeds can be fixed or moveable.

FIG. 9 shows detail of the top PCB for dual band element parasitic.

FIG. 10 shows one arrangement of alternating dual band and single band elements.

FIG. 11 shows one embodiment of the dual circular polarized feed with a dielectric plate for optimizing axial ratio and cross polarization.

FIG. 12 is a graph showing two sets of patterns representing two sets of beams of different frequency bands.

FIG. 13 is a graph showing patterns as in FIG. 12 where tracking of satellites operating in the lower frequency is done by combining adjacent lower frequency beams equally weighted.

FIG. 14 is a graph showing patterns as FIG. 12 where tracking of satellites operating on the lower frequency band is done by combining adjacent lower frequency beams unequally weighted.

FIG. 15 shows the schematic for using a wideband feed for two or more frequency bands with a single band feed using a diplexer to separate frequency bands from the wideband feed.

FIG. 16 shows another embodiment of a dual band arrangement where the higher frequency feed is integrated into the lower frequency feed.

FIG. 17 shows an RF lens array configuration with array of 7 lenses.

### DESCRIPTION OF THE INVENTION

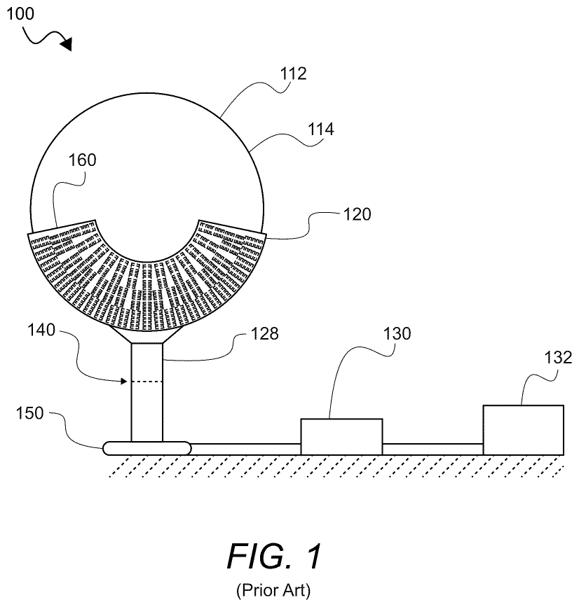

FIG. 1 shows a prior art system 100 of the U.S. Pat. No. 8,854,257 patent, based on the mono-pulse technique of determining target position. “The conformal array, Luneburg lens system 100 of the present invention has a Lunenburg lens 112 which is partially covered by a conformal array of patch antennas 120. The conformal array of patch antennas 120 is comprised of a multitude of patch antennas which are arranged in a shape to fit or conform to a portion of the surface 114, i.e., the outer contours, of the Lunenburg lens 112. The extent of the angular coverage provided by the patch antennas, i.e., the angular Field of Regard (FOR), is determined by the shape and size of the conformal array of patch antennas 120. The lens 112 and conformal array of patch antennas 120 are mounted on a surface 160 attached to base support 150. Base support 150 is connected to a conduit support 140 for supporting the lens 112 and patch antennas 120. Conduit Support 140 is hollow so as to allow electrical connection from the patch antennas 120 to the transmit/receive modules 128. The transmit/receive modules 128 connect to receiver/exciter module 130 which connects to processor 132.

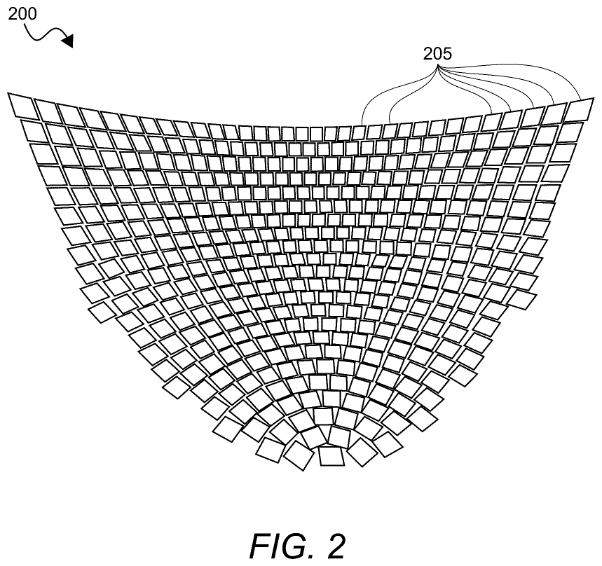

FIG. 2 shows an arrangement 200 of 454 feeds 205. These feeds illuminate a 180 cm diameter Luneburg lens. This is just one example of a given combination of two or more closely space feeds illuminating a multiple layers Luneburg lens that can be composed of two or more layers of decreasing dielectric constant with radius. The feeds can be closely spaced while maintaining acceptable coupling with adjacent and nearby feeds because of their planar nature. Similar feeds that have a more three-dimensional look will have stronger coupling to adjacent and nearby feeds deteriorating overall antenna performance.

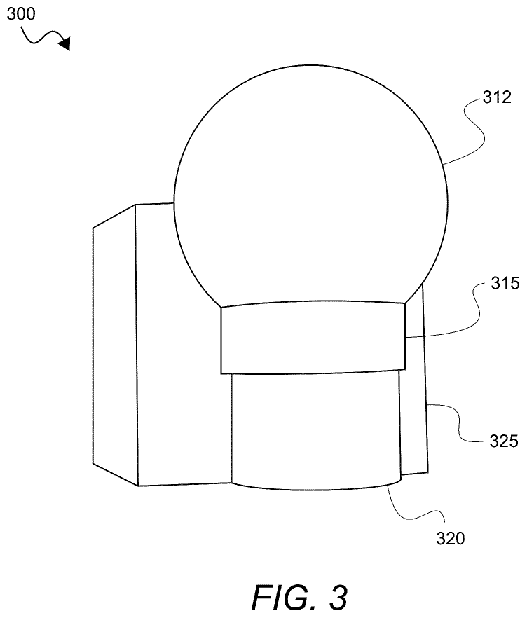

FIG. 3 shows a completed 180 cm lens with 454 S-band feeds (see 205) housed within housing 315. The antenna can connect to various transmit/receive devices to process data providing satellite tracking information. A number of these tracking techniques are described here. In this FIG. 312 is a radome that sits atop pedestals 315, 320, and equipment enclosure 325.

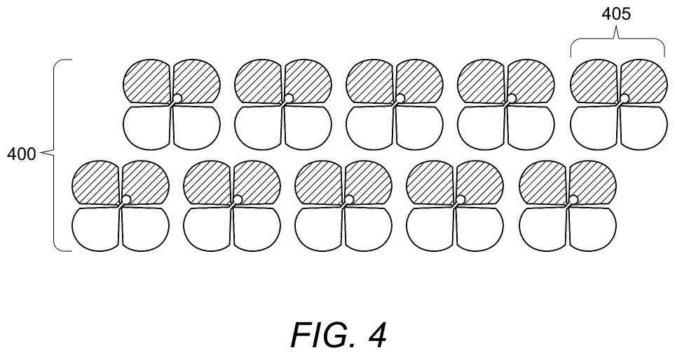

FIG. 4 shows a typical tightly packed array 400 of single band planar feeds 405. Planar feeds 405 of the “four square” variety shown are capable of low coupling levels to the adjacent and nearby elements or feeds. The drawing shows feeds as projected on a planar surface but in actual use the feeds are arranged as shown in FIG. 2, conformally around a spherical, preferably Luneburg, lens. As used herein, the term spherical lens includes lenses of any shape where the relevant beams pass through a portion of the lens that appears spherical to the beams.

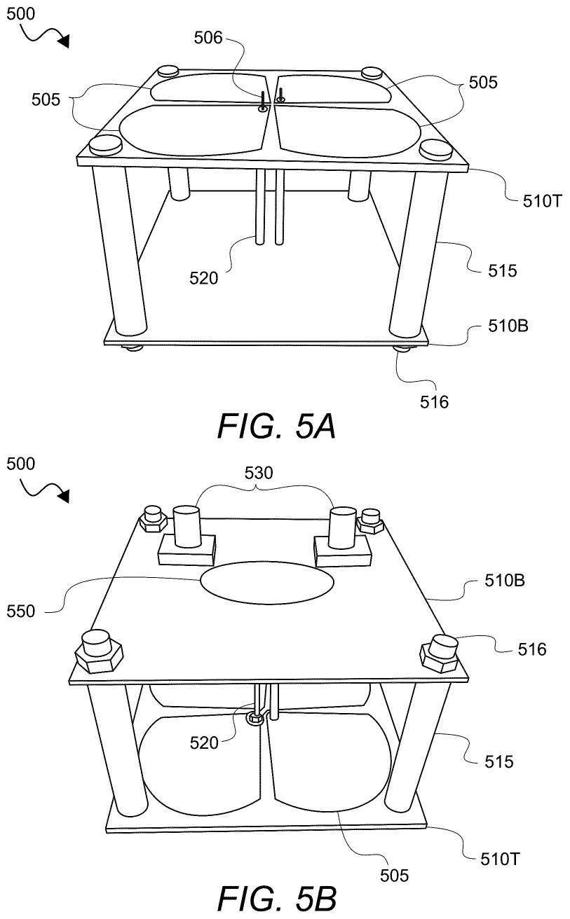

FIGS. 5A and 5B show detailed views of the top and bottom, respectively of one embodiment of a planar dual circular, right hand and left hand, feed 500. The top of the feed 500 comprises of top printed circuit board that supports two sets of planar dipole arms 505. The arms are not thin like a textbook dipole, but are two dimensional more in the shape of a square which is where the name “four square” is derived. Signals are passed through coaxial cable 520 and feed points 506. The bottom of feed 500 comprises a printed circuit board that supports hybrid chip 550. Structurally, feed 500 includes standoff 515, nuts 516, and mechanical connectors 530. The assembly has two printed circuit boards (PCBs). PCB 510T, for the top PCB, contains the printed dipole arms 505. PCB 510B, for the bottom PCB, contains the PCB that the 90 degree hybrid chip 550 is attached.

The dual polarized feed 500 is constructed from two planar dipole arm pairs 505. The dipoles 505 are fed with thin coaxial cable 520 where one dipole arm is fed with the center conductor and one dipole arm is fed with the outer conductor of the coax cable. This arrangement is repeated with the second dipole which is at a 90-degree orientation to the first dipole.

The dipole arms 505 are deposed approximately one quarter wavelength above the ground plane of the assembly. The outer side of the coax outer conductor 520 serves the function of a balanced to unbalanced (balun) transformer. A dipole must be fed by a balanced voltage of equal value and of opposite polarity to ground for the radiator to function properly. In this case the outer shield of the coax cable 520 acts as a two wire transmission line in air that is short circuited at the ground layer located one quarter wave from the dipole feed points 506 The impedance of the two wire transmission line is zero impedance at the ground layer and transformed over a quarter wavelength (which can be represented as a 180 rotation on a Smith Chart) to infinite impedance at the connection to the dipole. This prevents currents from traveling down the outside of the two wire transmission line maximizing the current into the dipole arms and resulting in an equal balanced voltage at the dipole inputs.

The bottom of the feed 500 shows a 90 degree hybrid chip 550, the two inputs to the chip are the signals from the two dipoles and the outputs are a combined in phase and quadrature signals at one port and a combined in phase and negative quadrature and the other port or right hand circular polarization (RHCP) and left hand circular polarization (LHCP).

The connectors 530 shown in FIG. 5A, 5B are SMA, but this is a design choice, any connector could be used or the transmission line containing RHCP and LHCP can be routed to other devices such as low noise block down converters (LNBs) without connectors between the devices.

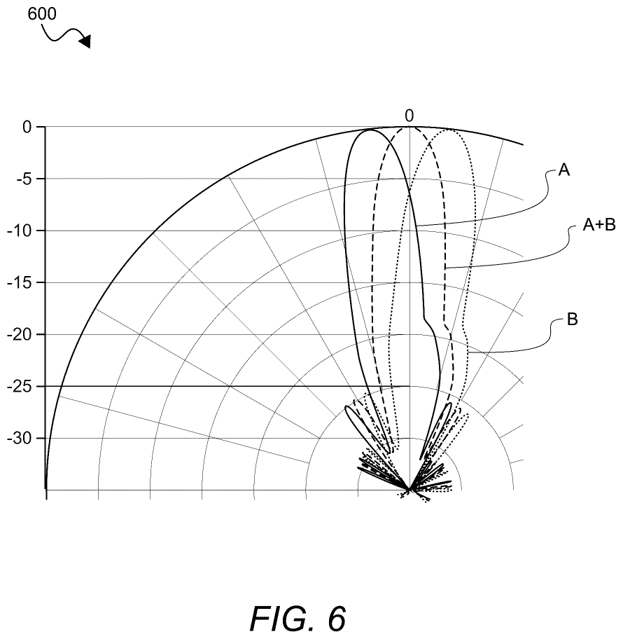

FIG. 6 is a graph 600 showing one method of tracking non-geosynchronous satellites. Beam A and Beam B are patterns from two adjacent individual feeds. For geosynchronous satellites the system can be designed so that a particular feed is positioned for maximum reception or transmission to a given satellite. When the satellites are moving in reference to the fixed sky they need to be tracked. The method shown consists of creating a composite beam between Beam A and Beam B, the “A+B” beam. Depending on the required resolution for tracking this selection of “A”, or “B”, or “A+B” may be sufficient to determine satellite position. In this embodiment only two feeds are used. If there is a large arrangement of feeds several processes like this can occur simultaneously to track a number of satellites. What is not shown is the details of the processing. For receive applications this would consist of a low noise block downconverter and an A/D to create a digital signature that is processed to yield a specific position.

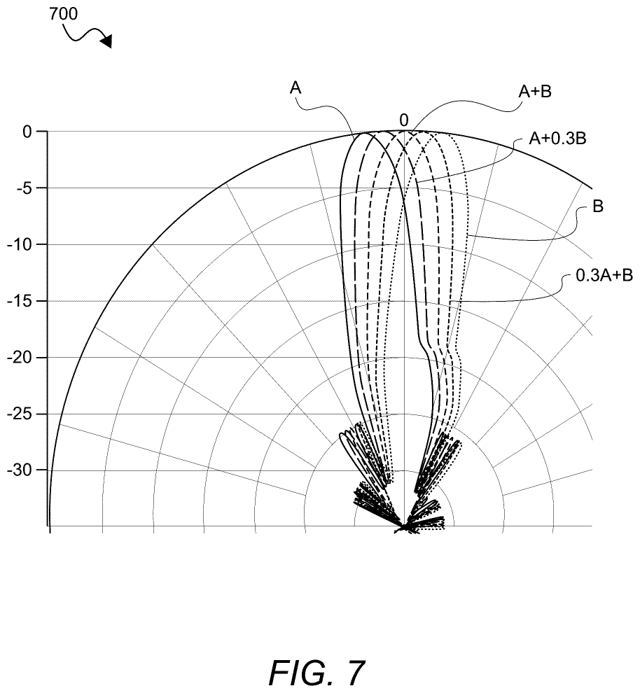

FIG. 7 is a graph 700 showing a processing scheme similar to FIG. 6 but higher satellite position resolution is achieved by giving unequal weights to the two beams used to form the composite beam. If the satellite is first observed with maximum power into Beam A the transition to maximum power into Beam B is made gradually by adjusting the relative weights applied to Beam A and Beam B. Initially a larger weight is given to Beam A in the composite beam and this weight is transitioned to larger weight to Beam B in the composite beam. The tradeoff is accuracy at the expense of additional processing steps.

It should be apparent to those skilled in the art that the steps described above can apply to several feeds. As an example, if we have feeds A, B, and C arranged in a planar arrangement the processing algorithm can create a composite beam applying different weightings to the component A, B, and C beams.

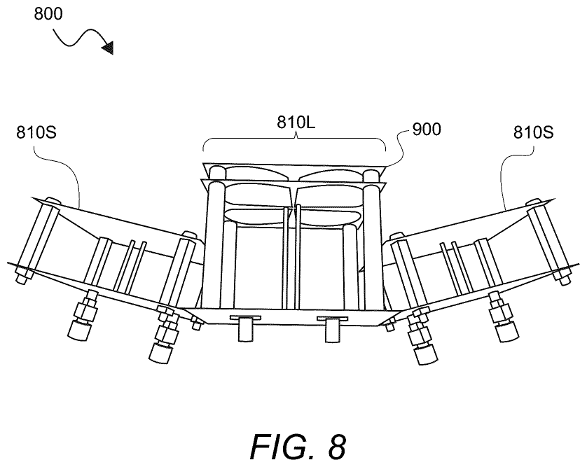

FIG. 8 shows a dual band feed arrangement 800 with an L-Band element 810L in the middle and adjacent S-Band feeds 810S on either side of the L-Band element 810L. FIG. 8 shows a fixed arrangement, but in a more general embodiment the higher frequency pair of elements 810S can move relative to the lower frequency element 810L to provide improved overall performance for the two frequency bands. For the case shown, the element construction for both bands is of the same type described in FIG. 5 for element 500. Alternatively, the center element shown can be a wide band element designed to cover multiple bands such as L-Band and S-Band. The top PCB 900 is a parasitic.

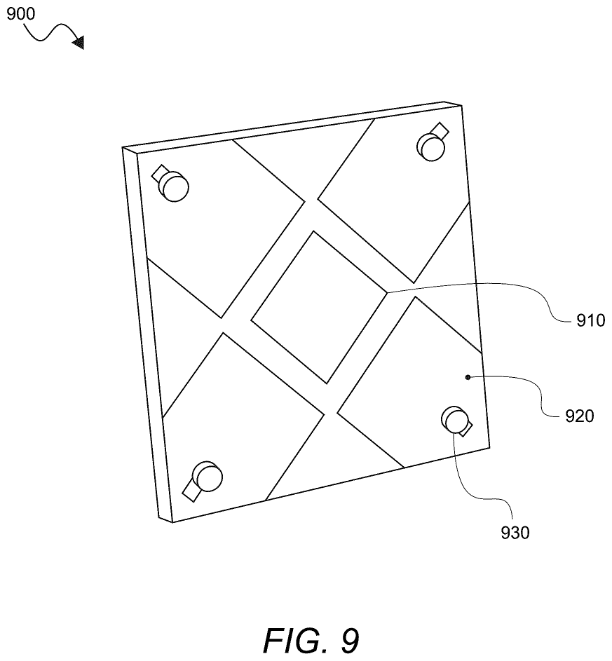

FIG. 9 shows detail of the top PCB 900 (parasitic) on the dual band feed. The metal features 910, 920 on the PCB are a symmetric parasitic that improves band width performance without compromising isolation or cross-polarization performance. Stand offs 930 attach the parasitic 900 to the rest of the feed 810L.

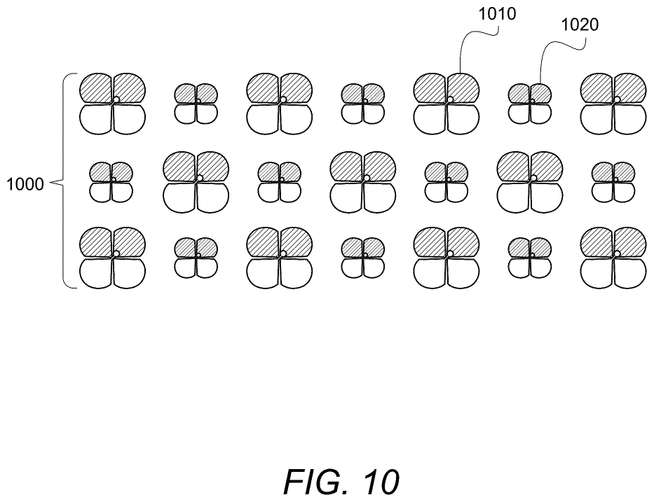

FIG. 10 shows an arrangement 1000 of dual band feeds (S plus L) 1010 with the smaller single band feeds(s) 1020.

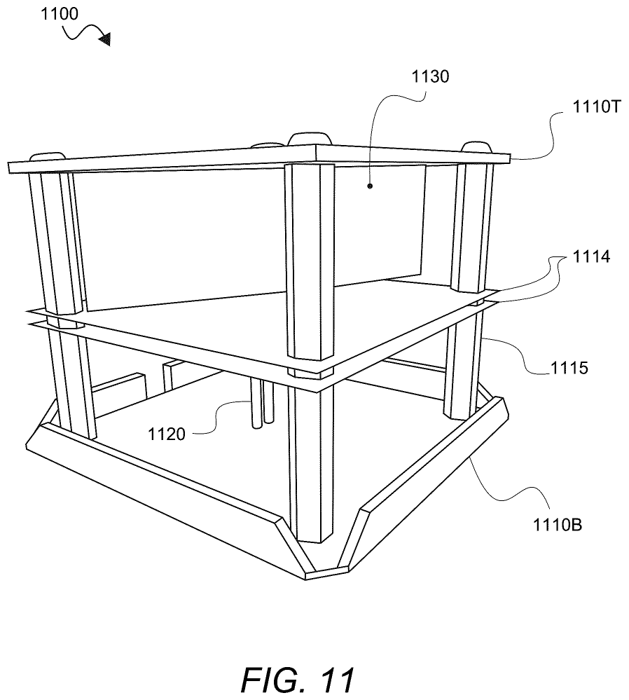

FIG. 11 shows a feed 1100 an S-band element with an additional thin plate dielectric 1120, which improves axial ratio and cross polarization. The method consists of using a thin plate of high dielectric constant (DK) material 1120, typically 10-15, which is placed diagonally across the top planar surface 1114 of the feed. When the plate 1120 is aligned with one of the two slant polarizations of the element, considerably more phase delay occurs compared to the orthogonal polarization. If the plate is then turned 45 degrees there is negligible impact due to the dielectric since it is equally in the two planes of polarization.

Feed 1110 is similar to feed 500 in that the top of the feed 1100 comprises of top printed circuit board 1110T that supports two sets of planar dipole arms (not shown). Signals are passed through coaxial cable 1120. The bottom of feed 1100 comprises a printed circuit board 1110B that supports hybrid chip (not shown). Structurally, feed 500 includes standoff 515, nuts 516, and mechanical connectors 530.

The choice of best position for the dielectric slab can be controlled remotely by using a mechanism to turn the dielectric slab under operation to optimize the resultant axial ratio from the RF lens. As used herein the term “optimize” and “optimizing” refer to commercially reasonable optimization, not absolute optimization.

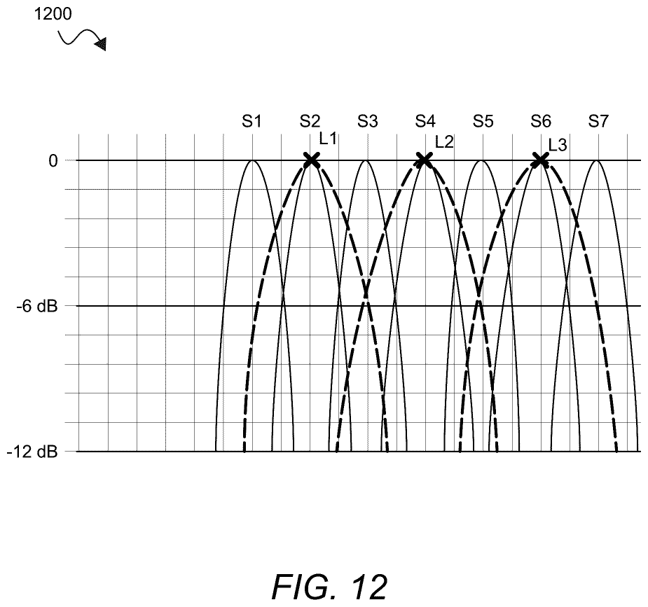

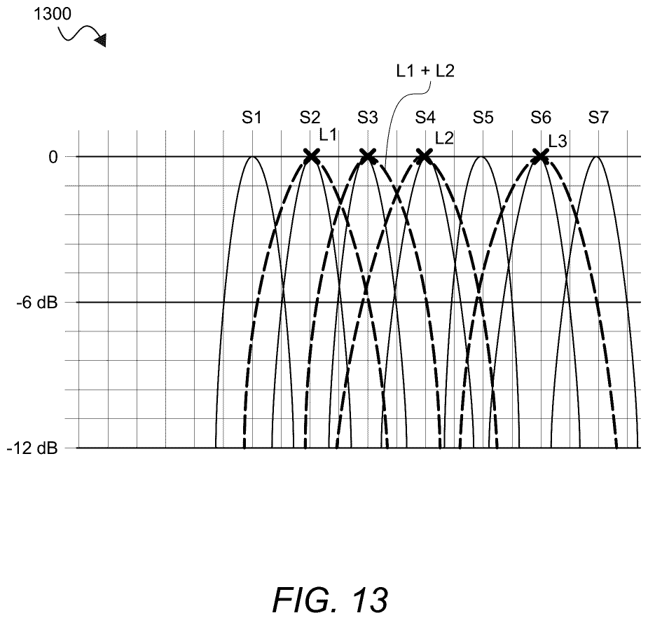

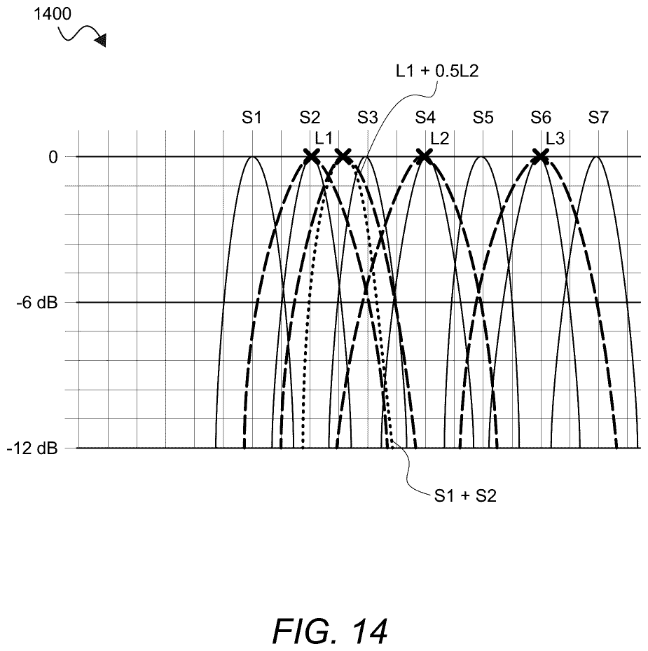

FIGS. 12-14 are graphs 1200, 1300, 1400 showing a set of dual band beams. The wider beams (heavy dashed lines) are for the lower frequency feed, and the narrower beams (thin solid lines) are for the higher frequency feed. As illustrated in FIGS. 13-14, dual-band smooth tracking (without gain loss in the gaps between beams) can be achieved by using a weighted beam combination, i.e. weighted summation of in-phase signals of neighbor beams.

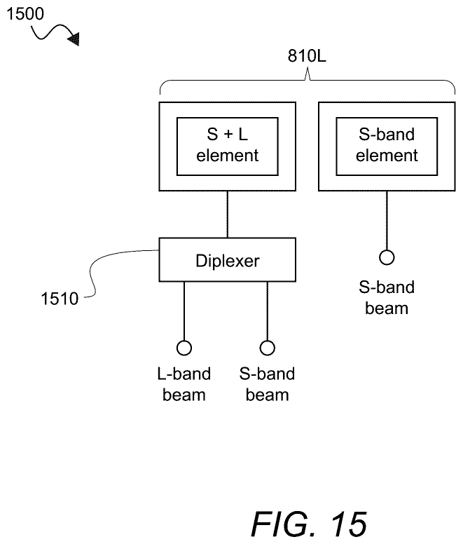

FIG. 15 relates to the case shown in FIG. 8 where the center element 810L is a wideband element, for example an element that covers both L-Band and S-band. For this situation a diplexer 1510 can be used to separate L-Band and S-band in the center element.

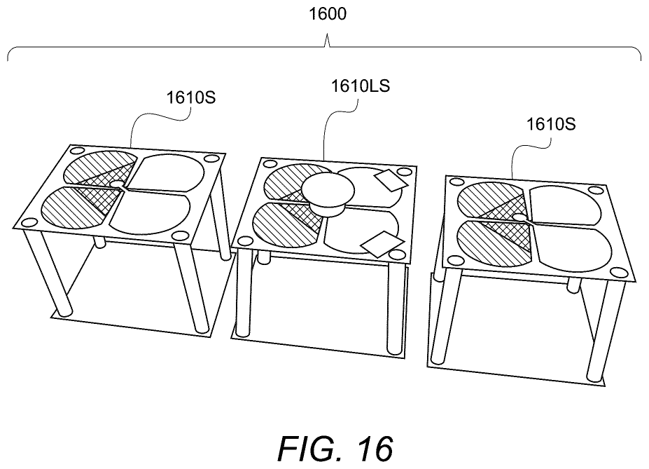

FIG. 16 shows a dual band configuration 1600 where the higher frequency element 1610LS is integrated into the lower frequency element. As in FIG. 8, some embodiments allows the higher frequency pair of side elements 1610S can move relative to 1610LS element.

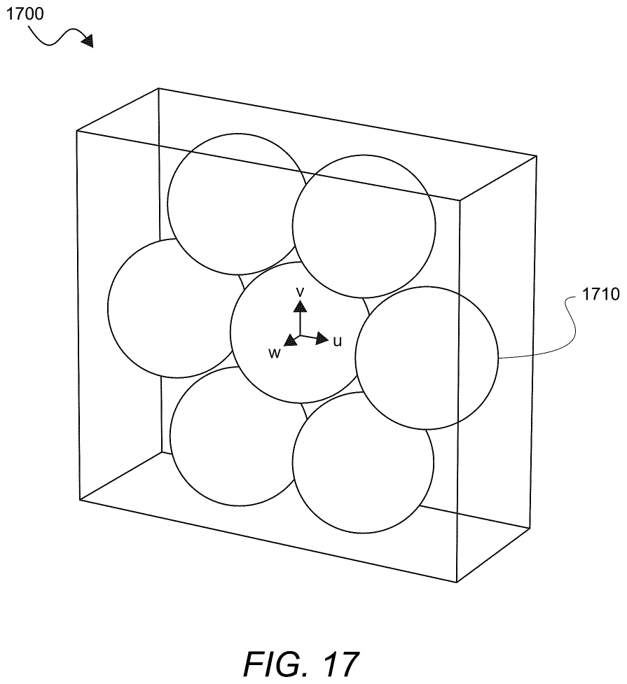

FIG. 17 shows an array 1900 of 7 RF lenses 1910. The approach described here can be extended to more than one RF lens. A typical array of lenses is a 2-3-2 arrangement as shown. When lenses are arrayed the signals from each lens must be processed to achieve the array gain. The scenario envisioned here is for each lens to have a receive chain including low noise block down converter (LNB) and Analog to Digital Converter (A/D) to obtain coherent receive signals from each lens that is then processed using one of several algorithms.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An antenna system for acquiring and tracking one or more satellites, the system comprising:
a spherical RF lens; and
at least two circularly polarized antenna elements used to feed the RF lens; and
a dielectric plate based parasitic above each element to improve the resultant antenna axial ratio;
wherein the received signal is processed to determine satellite location and track two or more satellites.

2. The antenna system of claim 1 where the received signal is processed where each feed is assigned to a given satellite.

3. The antenna system of claim 1 where a weighted combination of signals from two or more neighbor feeds is used to determine satellite position.

4. The antenna system of claim 3 where weighted combination is summation in phase.

5. The antenna system of claim 4 where dual band feeds are located between single band feeds.

6. The antenna system of claim 5 where number of dual band feeds and number of single band feeds are approximately the same.

7. The antenna system of 4 where each dual-band feed has diplexer to separate signals of different bands.

8. The antenna system of claim 4 where the higher frequency feed section is moveable relative to the lower frequency section.

9. The antenna system of claim 1 where the received signal is processed where a weighted combination of two or more feeds is used to determine satellite position.

10. The antenna system of claim 1 where dual band feeds are used to illuminate the lens.

11. The antenna system of claim 1 where two or more RF lenses are arrayed together.

12. A method to optimize the resultant axial ratio from an RF lens fed by a circular polarized feed using a dielectric plate oriented at an angle relative to the dipole axis to optimize axial ratio performance.

13. The method of claim 12 used in conjunction with the system described in claim 1.
